(19) United States
(12) Patent Application Publication
(10) Pub. No.: US 2011/0187875 A1
(43) Pub. Date: Aug. 4, 2011

(54) ROBOT FACE USED IN A STERILE ENVIRONMENT

(75) Inventors: Daniel Steven Sanchez, Summerland, CA (US); Kevin Hanrahan, Santa Barbara, CA (US); Charles S. Jordan, Santa Barbara, CA (US); David Bjorn Roe, Santa Barbara, CA (US); Yulun Wang, Goleta, CA (US); Marco Pinter, Santa Barbara, CA (US); Blair Whitney, Santa Barbara, CA (US)

(73) Assignee: InTouch Technologies, Inc., Goleta, CA (US)

(21) Appl. No.: 12/700,212

(22) Filed: Feb. 4, 2010

(51) Int. Cl. H04N 5/225; G05B 15/02

(52) U.S. Cl. 348/207.11; 700/275; 348/E05.026

(57) ABSTRACT

A robot system that includes a robot face with a monitor, a camera, a speaker and a microphone. The system may include a removable handle attached to the robot face. The robot face may be controlled through a remote controller. The handle can be remove and replaced with another handle. The remote controller can be covered with a sterile drape or sterilized after each use of the system. The handle and remote controller allow the robot to be utilized in a clean environment such as an operating room without requiring the robot face to be sterilized after a medical procedure. The robot face can be attached to a boom with active joints. The robot face may include a user interface that allows a user to individually move the active joints of the boom.

### BACKGROUND OF THE INVENTION

1. Field of the Invention

The subject matter disclosed generally relates to the field of robotic tele-presence systems.

2. Background Information

When performing a surgical procedure it is sometimes desirable to have a mentor assist in the procedure. Unfortunately, this typically requires that the mentor be at the surgical site which is not always practical. There has been developed a robotic system sold by Intuitive. Surgical, Inc. under the trademark Da Vinci which allows a surgeon to remotely perform a surgical procedure through use of robot arms located at the surgical site. This allows a specialist to actually perform a procedure from a remote location. The Da Vinci system is both large and expensive and thus not available for every medical facility. It would be desirable to allow remote medical consultation with a system that was relatively inexpensive and easy to install into existing operating rooms. It would also be desirable to provide a robot system that can be used in an operating room that does not need to be sterilized after each medical procedure.

### BRIEF SUMMARY OF THE INVENTION

A robot system that includes a robot face with a monitor, a camera, a speaker and a microphone. The system may include a removable handle attached to the robot face. The robot face may be controlled through a remote controller.

### BRIEF DESCRIPTION OF THE DRAWINGS

FIG. 1 is an illustration of a tele-presence system;

FIG. 2 is an enlarged view of a robot face of the system;

FIG. 3 is a rear view of the robot face;

FIG. 4 is an illustration of an alternate embodiment of the tele-presence system;

FIG. 5 is a rear view of a robot face of the embodiment shown in FIG. 4;

FIG. 6 is an illustration of a display user interface of a remote station;

FIG. 7 is a display user interface showing an electronic medical record;

FIG. 8 is a display user interface showing an image and an electronic medical record being simultaneously displayed;

FIG. 9 is a front view of a robot face that has a removable handle and can be controlled through a wireless remote controller;

FIG. 10 is a perspective view of an illustration of a robot system that includes a robot face attached to a boom with active joints;

FIG. 11 is front view of a graphical user interface that allows a user to individually move different joints of the boom shown in FIG. 10; and,

FIG. 12 is a perspective rear view showing a robot face with integrated computer components.

### DETAILED DESCRIPTION

Disclosed is a robot system that includes a robot face with a monitor, a camera, a speaker and a microphone. The system may include a removable handle attached to the robot face. The robot face may be controlled through a remote controller. The handle can be remove and replaced with another handle. The remote controller can be covered with a sterile drape or sterilized after each use of the system. The handle and remote controller allow the robot to be utilized in a clean environment, such as an operating room, without requiring the robot face to be sterilized after a medical procedure. The robot face can be attached to a boom with active joints. The robot face may include a user interface that allows a user to individually move the active joints of the boom.

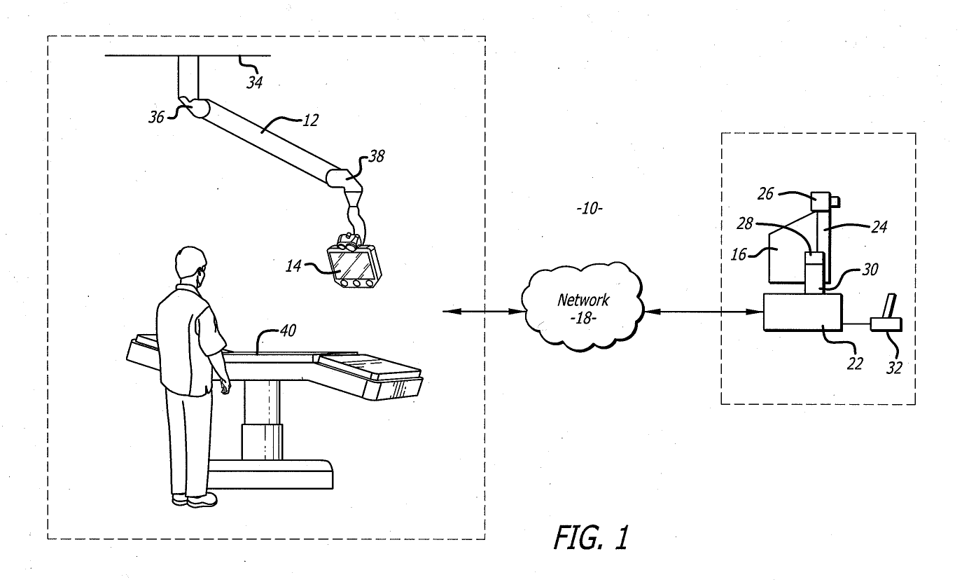

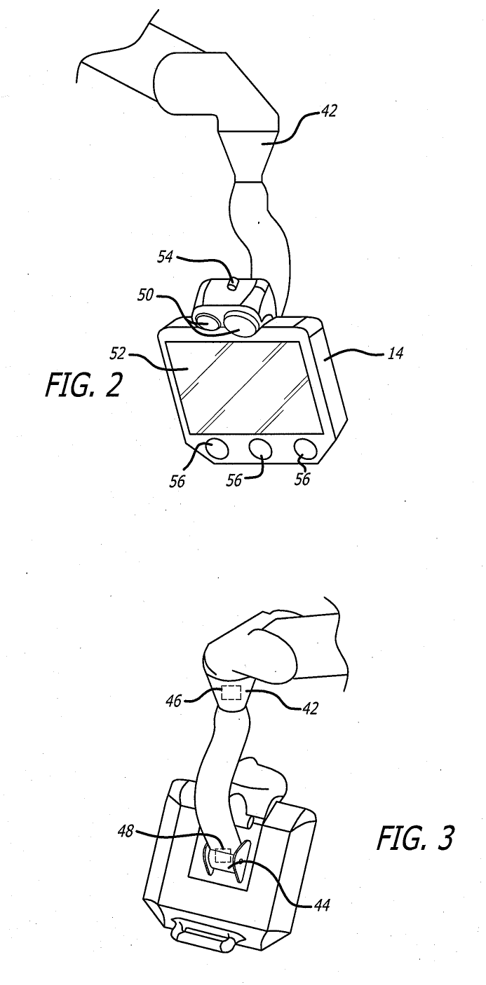

Referring to the drawings more particularly by reference numbers, FIGS. 1, 2 and 3 show a tele-presence system 10. The system 10 includes a boom 12, a robot face 14 and a remote control station 16. The remote control station 16 may be coupled to the robot face 14 through a network 18. By way of example, the network 18 may be either a packet switched network such as the Internet, or a circuit switched network such as a Public Switched Telephone Network (PSTN) or other broadband system. Alternatively, the robot face 14 may be coupled to the remote station 16 network thru a satellite.

The remote control station 16 may include a computer 22 that has a monitor 24, a camera 26, a microphone 28 and a speaker 30. The computer 22 may also contain an input device 32 such as a joystick or a mouse. The control station 16 is typically located in a place that is remote from the robot face 14. Although only one remote control station 16 is shown, the system 10 may include a plurality of remote stations 16. In general any number of robot faces 14 may be coupled to any number of remote stations 16 or other robot faces 14. For example, one remote station 16 may be coupled to a plurality of robot faces 14, or one robot face 14 may be coupled to a plurality of remote stations 16, or a plurality of robot faces 14. The system may include an arbitrator (not shown) that control access between the robot face(s) 14 and the remote stations 16.

The boom 12 may extend from the ceiling 34 of a medical facility. The boom 12 may include articulate joints 36 and 38 that provide at least two degrees of freedom and allow a user to move the robot face 14 relative to an medical table 40 such as an operating room (“OR”) table.

The boom 12 may have additional joints 42 and 44 that allow the robot face 14 to be panned and tilted, respectively. The joints 42 and 44 may contain actuators 46 and 48, respectively, that can be remotely actuated through manipulation of the input device 32 at the remote station 16.

Each robot face 14 includes a camera(s) 50, a monitor 52, a microphone(s) 54 and a speaker(s) 56. The robot camera 50 is coupled to the remote monitor 24 so that a user at the remote station 16 can view a patient on the table 40. Likewise, the robot monitor 52 is coupled to the remote camera 26 so personnel at the surgical site may view the user of the remote station 16. The microphones 28 and 54, and speakers 30 and 56, allow for audible communication between the system operator and the personnel at the surgical site.

The system 10 allows a system user such as a surgical specialist to view a patient on the table 40 and provide remote medical consultation through the remote station 16 and the robot face 14. Personnel at the surgical site can transmit questions and responses through the system back to the system operator. The robot camera 50 allows the specialist to view the patient and enhance the medical consultation. The robot monitor 52 can display the specialist to provide a feeling of presence at the surgical site. The boom 12 allows the personnel to move the robot face 14 into and out of the surgical area.

The robot face 14 can be retrofitted onto booms that presently exist in medical facilities. For example, some present medical facilities include a monitor attached to a boom. The existing monitor can be replaced with the robot face 14 that is then coupled to the remote station 16.

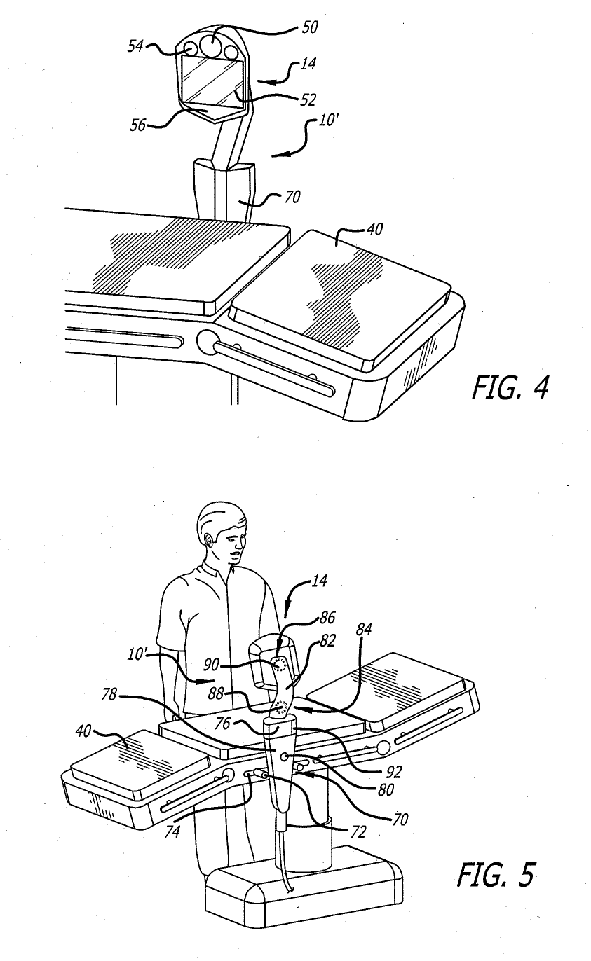

FIGS. 4 and 5 shows an alternate embodiment of a system 10′ where the robot face 14 is attached to the table 40 with an attachment mechanism 70. The attachment mechanism 70 may include a pair of clamps 72 that are pressed into a rail 74 of the table 40. The attachment mechanism 70 may have a sleeve 76 that slides relative to a housing 78 so that a user can adjust the height of the robot face 14. The face position may be locked in place by rotation of knob 80.

The attachment mechanism 70 may include a neck portion 82 with joints 84 and 86 that allow for pan and tilt of the robot face 14, respectively. The joints 84 and 86 may be manually actuated or contain actuators 88 and 90, respectively, that can be actuated through the input device 32 at the remote station 16.

The attachment mechanism 70 may include handles 92 that allow a user to carry the robot face 14 to and from the table 40. The attachment mechanism 70 allows the robot face 14 to be readily utilized at a surgical site, particularly when the operating room does not have a boom.

The remote station computer 22 may operate Microsoft OS software and WINDOWS XP or other operating systems such as LINUX. The remote computer 22 may also operate a video driver, a camera driver, an audio driver and a joystick driver. The video images may be transmitted and received with compression software such as MPEG CODEC.

The systems 10 and 10′ may have certain components and software that are the same or similar to a robotic system provided by the assignee InTouch Technologies, Inc. of Goleta, Calif. under the name RP-7 and embodies a system described in U.S. Pat. No. 6,925,357, which is hereby incorporated by reference.

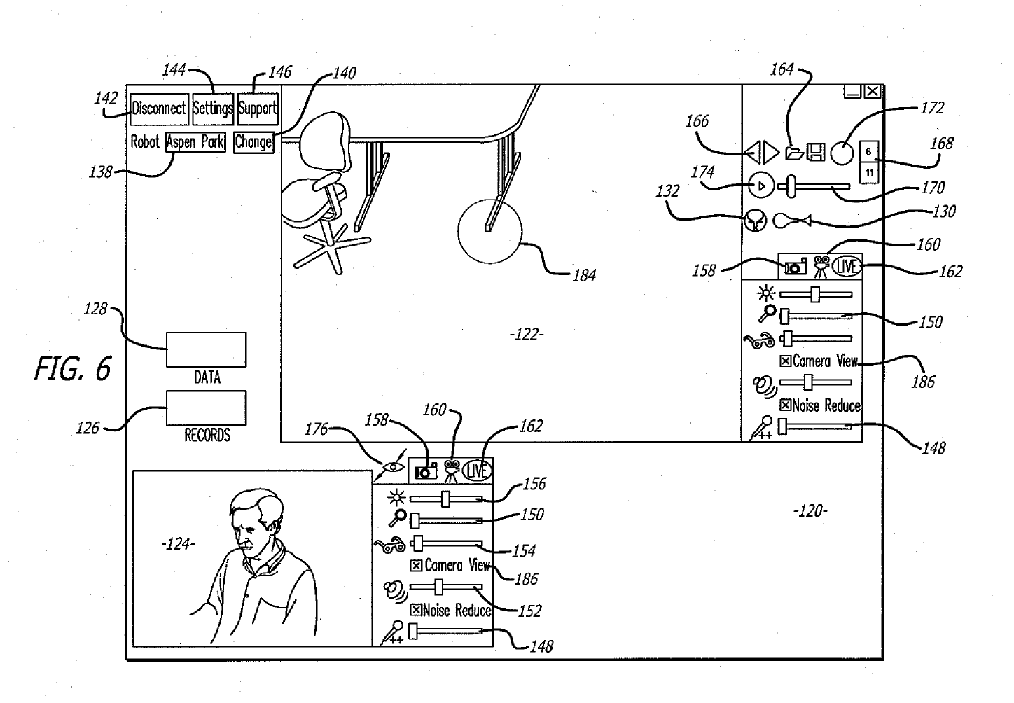

FIG. 6 shows a display user interface (“DUI”) 120 that can be displayed at the remote station 16. The DUI 120 may include a robot view field 122 that displays a video image captured by the camera of the robot face 14. The DUI 120 may also include a station view field 124 that displays a video image provided by the camera of the remote station 16. The DUI 120 may be part of an application program stored and operated by the computer 22 of the remote station 16.

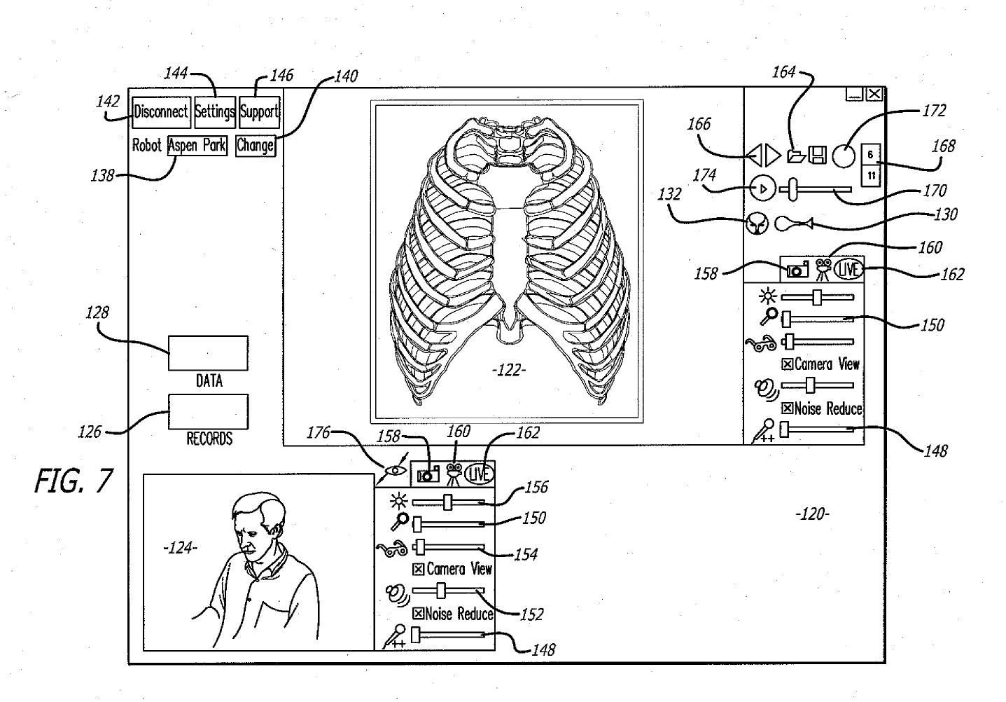

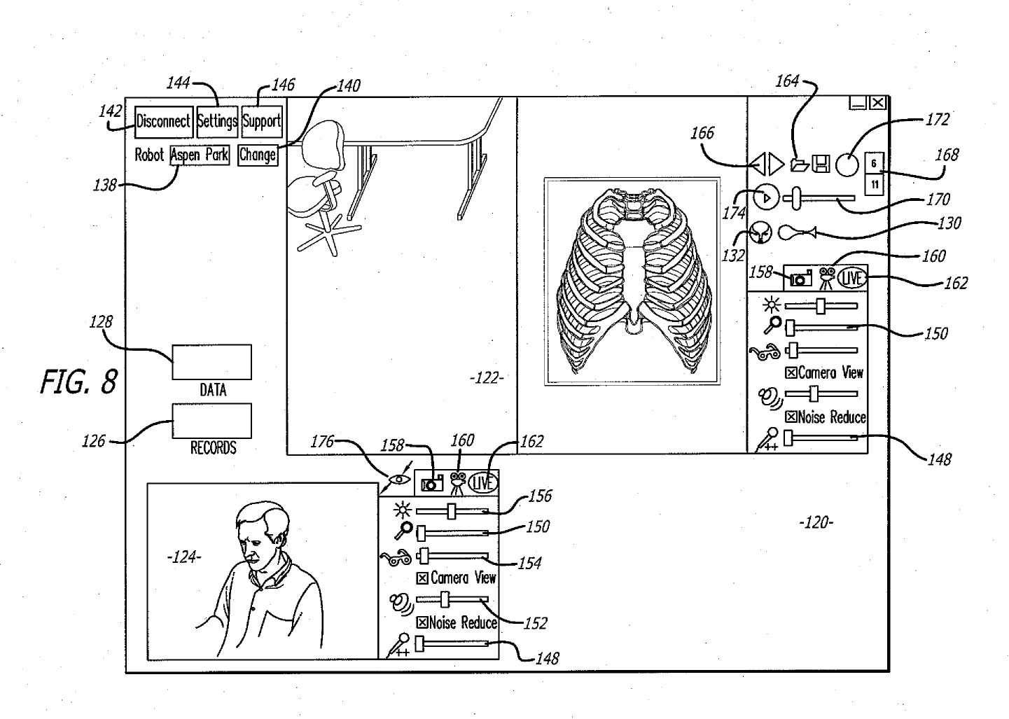

The DUI 120 may include a graphic button 126 that can be selected to display an electronic medical record as shown in FIG. 7. The button 126 can be toggled to sequentially view the video image and the electronic medical record. Alternatively, the view field 122 may be split to simultaneously display both the video image and the electronic medical record as shown in FIG. 8. The viewing field may allow the physician to modify the medical record by adding, changing or deleting all or part of the record. The remote clinician can also add to the medical record still images or video captured by the camera of the robot.

The DUI 120 may have a monitor data field 128 that can display the data generated by a medical monitoring device(s) (not shown) and transmitted to the remote station. The data can be added to the electronic medical record, either automatically or through user input. For example, the data can be added to a record by “dragging” a monitor data field 128 into the viewing field 122.

The DUI 120 may include alert input icons 130 and 132. Alert icon 130 can be selected by the user at the remote station to generate an alert indicator such as a sound from the speaker of the robot face 14. Selection of the icon generates an alert input to the robot face 14. The robot face 14 generates a sound through its speaker response to the alert input. By way of example, the sound may simulate the noise of a horn. Consequently, the icon 130 may have the appearance of a horn.

Alert icon 132 can be selected to request access to the video images from the robot face. The default state of the robot may be to not send video information to the remote station. Selecting the alert icon 132 sends an alert input such as an access request to the robot face. The robot face then generates an alert indicator. The alert indicator can be a sound generated by the robot speaker, and/or a visual prompt on the robot monitor. By way of example, the visual prompt may be a “flashing” graphical icon. The sound may simulate the knocking of a door. Consequently, the alert icon 132 may have the appearance of a door knocker.

In response to the alert indicator the user may provide a user input such as the depression of a button on the robot face, or the selection of a graphical image on the robot monitor, to allow access to the robot camera. The robot face may also have a voice recognition system that allows the user to grant access with a voice command. The user input causes the robot face to begin transmitting video images from the robot camera to the remote station that requested access to the robot face. A voice communication may be established before the cycle of the alert input and response, to allow the user at the remote station to talk to the caller recipient at the robot face.

The DUI 120 may include a location display 138 that provides the location of the robot face. The CHANGE button 140 can be selected to change the default robot face in a new session. The CHANGE button 140 can be used to select and control a different robot face in a system that has multiple robot faces. The user can initiate and terminate a session by selecting box 142. The box 142 changes from CONNECT to DISCONNECT when the user selects the box to initiate a session. System settings and support can be selected through buttons 144 and 146.

Both the robot view field 122 and the station view field 124 may have associated graphics to vary the video and audio displays. Each field may have an associated graphical audio slide bar 148 to vary the audio level of the microphone and another slide bar 152 to vary the volume of the speakers.

The DUI 120 may have slide bars 150, 154 and 156 to vary the zoom, focus and brightness of the cameras, respectively. A still picture may be taken at either the robot face or remote station by selecting one of the graphical camera icons 158. The still picture may be the image presented at the corresponding field 122 or 124 at the time the camera icon 158 is selected. Capturing and playing back video can be taken through graphical icons 160. A return to real time video can be resumed, after the taking of a still picture, captured video, or reviewing a slide show, by selecting a graphical LIVE button 162.

A still picture can be loaded from disk for viewing through selection of icon 164. Stored still images can be reviewed by selecting buttons 166. The number of the image displayed relative to the total number of images is shown by graphical boxes 168. The user can rapidly move through the still images in a slide show fashion or move through a captured video clip by moving the slide bar 170. A captured video image can be paused through the selection of circle 174. Play can be resumed through the same button 174. Video or still images may be dismissed from the active list through button 172. Video or still images may be transferred to the robot by selecting icon 176. For example, a doctor at the remote station may transfer an x-ray to the screen of the robot.

The system may provide the ability to annotate 184 the image displayed in field 122 and/or 124. For example, a doctor at the remote station may annotate some portion of the image captured by the robot face camera. The annotated image may be stored by the system. The system may also allow for annotation of images sent to the robot face through icon 176. For example, a doctor may send an x-ray to the robot face which is displayed by the robot screen. The doctor can annotate the x-ray to point out a portion of the x-ray to personnel located at the robot site. This can assist in allowing the doctor to instruct personnel at the robot site.

The display user interface may include graphical inputs 186 that allow the operator to turn the views of the remote station and remote cameras on and off.

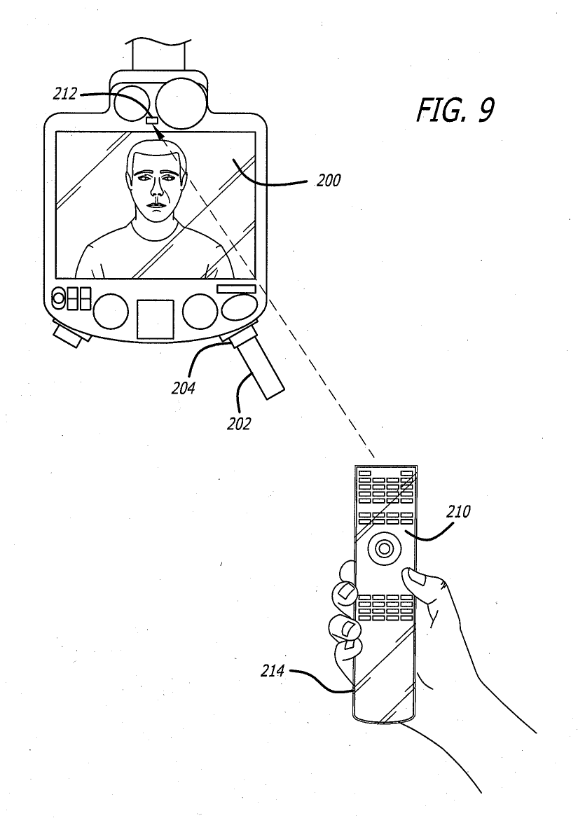

FIG. 9 shows a robot face 200 that has a handle 202 that can be grasped by an operator and used to move the face 200. The handle 202 may include threads (not shown) or other mechanical features for attachment and detachment from a mount 204 of the robot 200. This allows the handle 202 to be removed and replaced with another handle. The handle 202 can be constructed to be disposable and/or sterilized for later use. The handle 202 provides a feature that allows a user to move the robot face 200 without making contact with and contaminating the face 200.

The robot face 200 can be controlled through a remote controller 210. The robot face 200 may include a wireless transceiver 212, such as infrared, that can receive and transmit wireless signals to the remote controller 210. The robot face 200 can execute a face function in response to the command. For example, the robot face 200 can be moved in response to signals transmitted by the remote controller 210.

The remote controller 210 can be covered with a protective drape 214 to prevent contamination. The remote controller 210 may also be constructed to be sealed to allow for sterilization of the control 210 and use without the drape 214. The remote controlled robot face 200 may be attached to a boom or mounted to a table as shown in FIGS. 1 and 4, respectively. The handle 202 and/or remote controller 210 allow the face to be easily used in a clean environment such as an operating room. After each medical procedure the handle 202 can be removed and replaced with another handle. The sterile drape of the remote controller 210 can also be replaced for use in another procedure. Alternatively, the remote controller 210 can be sterilized.

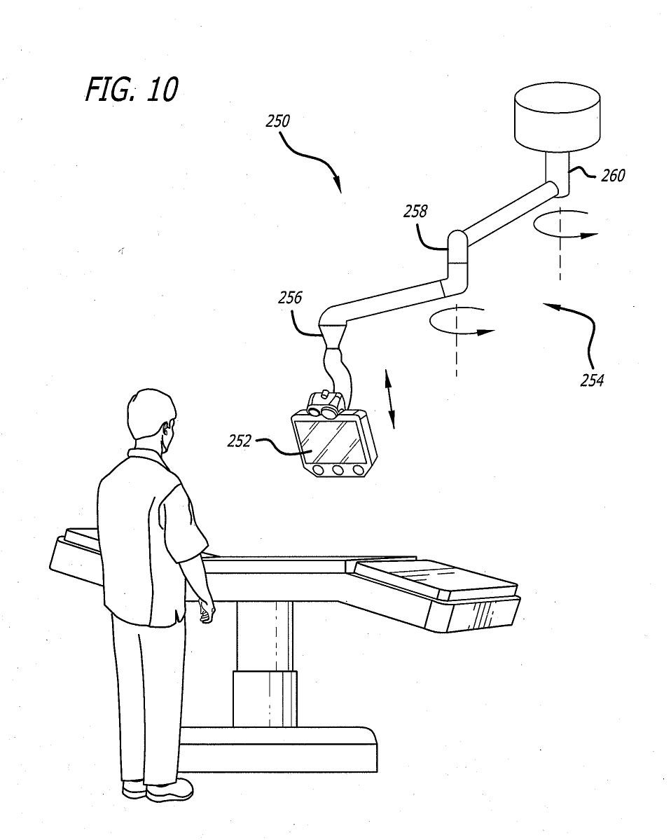

FIG. 10 shows a robot system 250 that includes a robot face 252 attached to a boom 254. The boom 254 has active joints 256, 258 and 260 that provide the degrees of freedom indicated by the arrows. The boom 254 can be moved through a remote control station (not shown). The boom 254 may also be controlled through the remote controller shown in FIG. 9.

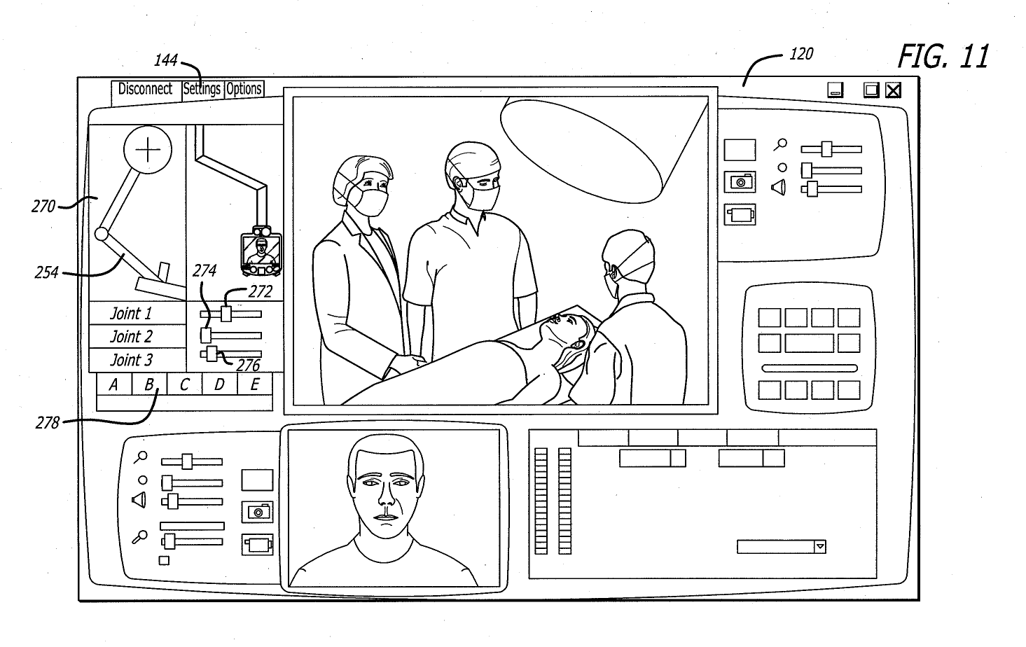

As shown in FIG. 11, selecting the settings button(s) 144 of the DUI 120 can cause the display of a boom interface 270 that allows a user to individually move the different joints of the boom 254. The interface 270 may include a depiction or live image of the boom 254 with reference numbers to the different boom joints, shown as Joint 1, Joint 2 and Joint 3.

The interface 270 includes graphical slide bars 272, 274 and 276 that can be manipulated by the user to move each corresponding joint. By way of example, slide bar 272 can be moved to cause a desired rotation of Joint 1. Slide bar 276 can be moved to cause a desired linear movement of Joint 3. The interface 270 may include memory buttons 278 A, B, C, D and E. The memory buttons 278 can be used to store positions of the boom 254, and return the boom 254 to the stored positions through selection of the buttons 278.

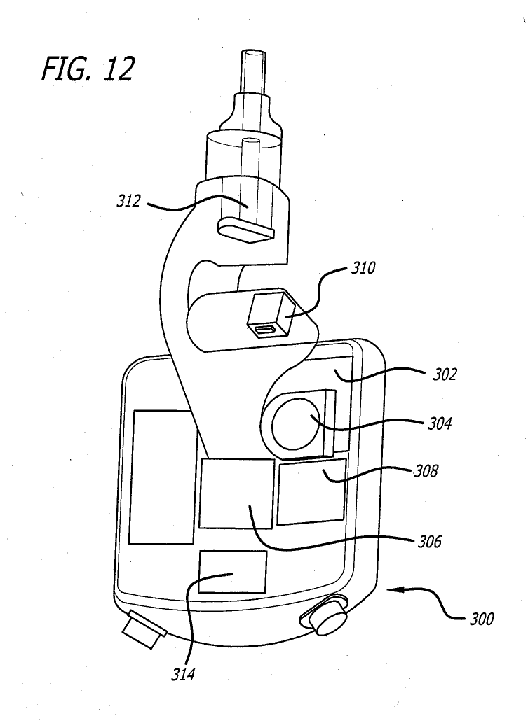

FIG. 12 shows an embodiment of a robot face 300 with the components of a computer integrated into the face 300. The face 300 includes a central processing unit (“CPU”) and a corresponding thermal heat spreader module 302. A fan 304 may be mounted adjacent to the CPU 302 to optimize heat transfer. The CPU 302 is coupled to a motherboard 306. The face 300 may also include a hard disk drive 308 or some other type of mass storage device. The CPU 302 and associated driver circuits (not shown) can provide signals to control movement of a tilt actuator 310 and a pan actuator 312 coupled to the robot face 300. The robot face 300 may also have a laser pointer 314 that is independently moved relative to the face 300 and controlled through the CPU 302. The robot face 300 includes the components of a computer that allow control of the face 300 from the robot site. For example, the robot face 300 can be controlled with the remote controller shown in FIG. 9. There is no need to receive control signals from a remote control station. The remote controller can be used to control the actuators 310 and 312, and laser pointer 314.

The robot faces disclosed can be used in an environment unsafe for humans. For example, the robot faces can be used to monitor a patient in an MRI or an X-ray room, or an inmate at a prison cell. An operator at a remote station can monitor the patient, inmate, etc. without having to be present in the room.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A robot system, comprising:
a robot face that has a monitor, a camera, a speaker and a microphone; and,
a removable handle attached to said robot face.

2. The system of claim 1, further comprising a boom attached to said robot face.

3. The system of claim 1, further comprising a remote controller coupled to said robot face.

4. The system of claim 1, wherein said robot face includes a CPU, a hard disk drive and a wireless transceiver.

5. The system of claim 3, wherein said boom has a plurality of actuators, said robot face includes a CPU, a hard disk drive and a wireless transceiver that are coupled to said actuators to create movement of said robot face in response to signals from said remote control.

6. A method for operating a robot face, comprising:
moving a robot face with a first handle; and,
replacing the first handle with a second handle.

7. The method of claim 6, further comprising controlling the robot face through a remote controller.

8. The method of claim 7, further comprising transmitting a signal from the remote controller to actuate an actuator of a boom attached to the robot face.

9. A robot system, comprising:
a robot face that has a monitor, a camera, a speaker, a microphone and a wireless transceiver; and,
a remote controller that is coupled to said wireless transceiver.

10. The system of claim 9, further comprising a sterile drape that covers said remote controller.

11. The system of claim 9, wherein said remote controller is constructed to be sterilized.

12. A method for operating a robot face, comprising:
transmitting a signal from a remote controller to a robot face; and,
executing a robot face function in response to the signal from the remote controller.

13. The method of claim 12, wherein the robot face function includes moving the robot face.

14. A robot system, comprising:
a boom that has a plurality of active joints;
a robot face that is attached to said boom, said robot face includes a monitor, a camera, a speaker and a microphone; and,
a user interface that allows a user to individually move said joints of said boom.

15. The system of claim 14, wherein said user interface includes a plurality of graphical slide bars that can be moved to move said boom joints.

16. The system of claim 14, wherein said interface includes at least one memory button that can be selected to move said boom to a desired position.

17. A method for moving a robot face, comprising:
providing a robot face that is attached to a boom with a plurality of active joints;
manipulating a user interface; and,
moving individually the active points of the boom in response to manipulation of the user interface.

18. The method of claim 17, wherein the manipulation of the user interface includes moving one or more graphical slide bars.

19. The method of claim 17, wherein the manipulation of the user interface includes selecting one or more graphical memory buttons.

20. A robot, comprising:
a boom that has a plurality of active joints; and,
a robot face that is attached to said boom, said robot face includes a monitor, a camera, a speaker and a microphone, said robot face further having a CPU, a hard disk drive and a wireless transceiver, said CPU provides signals to said active joints of said boom in response to a signal received by said wireless transceiver.

21. The system of claim 20, wherein said robot face includes a laser pointer that receives signals from said CPU in response to signals received by said wireless transceiver.

22. The system of claim 20, further comprising a removable handle attached to said robot face.
